(19) United States
(12) Patent Application Publication
(10) Pub. No.: US 2021/0237503 A1
(43) Pub. Date: Aug. 5, 2021

(54) PAINTING TRAY DEVICES

(71) Applicant: Christopher Fokas, Amherst, NH (US)

(72) Inventor: Christopher Fokas, Amherst, NH (US)

(21) Appl. No.: 16/777,284

(22) Filed: Jan. 30, 2020

(51) Int. Cl. B44D 3/12

(52) U.S. Cl. CPC B44D 3/12

(57) ABSTRACT

Devices and assemblies are disclosed that may facilitate painting, and more specifically, devices are disclosed that may facilitate the painting of surfaces when using a paint can containing a quantity of paint a paint brush to perform the task. In accordance with aspects and embodiments, a device is disclosed comprising a support system, at least one suspender having a first end and a second end and extending from the support system and a paint tray having a plurality of through holes positioned at the second end of the at least one suspender. The device may be inserted into a can of paint the tray may be adjustably submerged into the paint. Paint may pass through the tray's holes and the paint may form a layer on top of the paint tray.

### FIELD OF DISCLOSURE

The present disclosure relates to devices and assemblies for paint, and more specifically, to devices and assemblies to aid in collecting paint onto a tool for application onto surface.

### BACKGROUND

Painting, be it exterior or interior applications, is considered one of the top home-improvement projects that adds value to property. In addition to the residential use of paint, paints are also used commercially in a wide range of industries. Painting however is often considered to be a tedious and laborious job at least in part because of the propensity of painting projects to become messy.

The application of paint to any surface, regardless of the tool being used, requires that the tool have the correct amount of paint thereon. If the tool does not take up enough paint, the paint on the tool will not adequately cover the surface. If, however, the tool has an excess of paint on it, the paint applied to the surface may drip.

Paint is supplied in cans. Generally, paint is transferred from the can into a secondary container for application to aid in obtaining a proper amount of paint on the painting tool. For example, paint is often poured into a paint tray in order to not only provide easier access to the paint, but also to facilitate the removal of excess paint from the tool prior to contacting the paint-containing tool with the surface to be painted. Paint trays thus typically have two components, a well and a plate. Paint is poured from the can into the well and taken up by the painting tool, i.e., a roller or a brush, by dipping the tool into the paint in the well. The roller or brush is then passed over the plate portion of the tray to remove excess paint on the painting tool. The plate portion of the tray is generally textured, such that when the brush/roller passes over the surface, excess paint on the tool is transferred back to the plate.

Transferring paint into the well of a paint tray can result in spills and paint drips on surfaces intended to remain paint-free. Moreover, after a project is completed, there often remains a quantity of paint in the well of the paint tray. This paint can be discarded or poured back into the can. Regardless, however, discarding or re-storing the extra paint can also be messy. There thus exists a need for a paint tray device that ameliorates the mess of painting by avoiding having to transfer paint from a paint can and back again. Additionally, paint trays are typically designed however for use with paint rollers. When using a paint brush, often too much paint remains on the brush even after passing the brush over the plate of the paint tray. Often, when using a brush to paint surfaces, painters simply dip the brush into the can of paint and wipe the excess paint off on the side of the can. While this method avoids the need to transfer paint into a tray, this method often causes paint to accumulate on the rim of the can, which in turn drips down the can and results in an unintended mess. Moreover, the paint that collects in the rim of the paint can often makes resealing the can difficult. There thus also exists a need for a paint tray device better suited for brush applications.

### SUMMARY OF DISCLOSURE

The present disclosure is directed to paint devices. In accordance with aspects and embodiments, a paint device is provided comprising a support system, a plurality of suspenders extending from the support system, a paint tray positioned at the end of the suspender opposite the support system and a stopper positioned below the paint tray to retain the paint tray on the suspenders. In accordance with embodiments, the paint tray comprises a plurality of through holes and the support system comprises a support ring having a top end and a bottom end and a support flange extending radially from the top end of the support ring.

In accordance with aspects and embodiments, the paint devices disclosed further comprise a plurality of ratchet boxes on the support ring that receive the suspenders, with each ratchet box having a corresponding suspender. Each ratchet box comprises a top end and a bottom end and the first end of the corresponding suspender extends from the top end and the second end of the corresponding suspender extends from the bottom end. The suspenders of the disclosed devices comprise a plurality of teeth and each ratchet box has a tang configured to mate with the teeth.

In accordance with embodiments, tang allows the suspender to pass through the ratchet box in a direction from the top of the ratchet box to the bottom of the ratchet box but the tang does not allow the suspender to pass through the ratchet box in a direction from the bottom of the ratchet box to the top of the ratchet box. This feature enables the distance between the paint tray and the support system to be increased by passing the suspender through the ratchet box in a direction from the top of the ratchet box to the bottom of the ratchet box. The distance between the paint tray and support system is increasable in increments corresponding to the size of the teeth on the suspenders. In some embodiments, the tang is releasable from the teeth. When the tang is released, the corresponding suspender can pass through the ratchet box in the direction from the bottom of the ratchet box to the top of the ratchet box.

In accordance with aspects and embodiments, the paint tray may further comprise a gasket surrounding its perimeter and the support system may comprise a lip onto which excess paint may be wiped when the device is in use.

In accordance with aspects and embodiments, the device is sized to be inserted into paint cans containing quantities of paint. The support flange rests on the top rim of the paint can and the distance between the support system and the paint tray is adjusted to submerge the paint tray in the quantity of paint. Paint passes through the holes in the tray and forms a thin layer of paint on the paint tray. This paint layer can then be taken up by a painting tool for application onto a surface to be painted.

In accordance with aspects and embodiments, a paint device is provided comprising a plurality of suspenders having teeth, where each suspender having a first end and a second end, and each first end has a hook and each second end has a foot. A paint tray comprising through holes is positioned between the plurality of hooks and plurality of feet. The paint tray includes plurality of ratchet boxes that receive the plurality of suspenders, with each ratchet box having a corresponding suspender. In accordance with embodiments, each ratchet box comprises a tang configured to mate with the teeth and the tang allows the paint tray to move on the suspenders in a direction from the first end of the suspenders towards the second end of the suspenders. The tang does not allow the paint try to move on the suspenders in a direction from the second end of the suspenders towards the first end of the suspenders. The distance between the paint tray and hooks is increasable by moving the paint tray down the suspenders in a direction from the first end of the suspenders towards the second end of the suspenders. In accordance with embodiments, the device is sized to be inserted into a paint can containing a quantity of paint. The hooks hook onto the top rim of the paint can and the distance between the hooks and the paint tray is adjusted to submerge the paint tray in the quantity of paint. Paint passes through the holes in the tray and forms a thin layer of paint on the paint tray. This paint layer can then be taken up by a painting tool for application onto a surface to be painted.

### BRIEF DESCRIPTION OF THE FIGURES

FIG. 1 shows a paint can containing paint known in the art;

FIG. 2 shows a device in accordance with aspects and embodiments of the present disclosure;

FIG. 3 shows an assembly including a device in accordance with aspects and embodiments of the present disclosure;

FIG. 4 shows an assembly including a device in accordance with aspects and embodiments of the present disclosure;

FIG. 5 shows an exploded view of a portion of a device in accordance with aspects and embodiments of the present disclosure;

FIG. 6A shows a portion of an embodiment of a device in accordance with aspects and embodiments of the present disclosure;

FIG. 6B shows a portion of another embodiment of a device in accordance with aspects and embodiments of the present disclosure;

FIG. 7 shows an assembly including a device in accordance with aspects and embodiments of the present disclosure; and

FIG. 8 shows an assembly including a device in accordance with aspects and embodiments of the present disclosure.

### DETAILED DESCRIPTION

The present disclosure is directed to devices and assemblies that facilitate the painting. The devices disclosed may be used with any type of paint. The devices and assemblies disclosed may be used in connection with standard paint cans but may also be used in any paint containing vessel able to accommodate the device. The devices and assemblies disclosed may be used for painting in residential, commercial, and industrial applications.

The devices and assemblies disclosed may be used with any paint tool, including but not limited to a paint brush or a paint roller, but most preferably are used with a paint brush. Paint is often applied with a paint brush when the surface to be covered is smaller. Paint brushes are often used for applications that involve the painting of trim, and for example, on baseboards, door frames, window casings, and railings. The painting of these surfaces is often done with a brush that is repeatedly dipped into a quantity of paint in a paint can. Excess paint on the brush is removed from the brush by wiping the brush on the top rim of the paint can. Alternatively, paint may be poured from the can into the well of a paint tray. A brush may be dipped into the well of the paint tray and excess paint may be discarded by passing the brush over a textured plate of the tray. Both methods have substantial drawbacks.

When paint is collected on a brush directly from the can and the excess wiped off onto the rim of the can, the excess paint collects and often drips from the can, which can result in paint dripping onto surfaces not intended to receive paint, causing a mess and requiring clean-up while simultaneously painting the desired surface. Another hazard of dipping a brush directly into the can results when older or lower quality brushes are used. Brushes may shed bristles into the paint and removing them from the quantity of paint in the can often results in significant mess. If they're not removed, however, they can be transferred to the surface being painted, which is also undesirable. Moreover, the accumulation of excess brush paint in the rim of the can often make resealing the paint can difficult. When cans are not adequately sealed after use, the remaining paint can dry out and become unusable for future applications. To avoid this, after brush painting directly from the can, a user must often clean the can, adding yet another clean-up step to the project.

A user seeking to avoid an over accumulation of paint on the rim of the can may therefore dip only a fraction of the brush into the paint. Applying paint from a brush having too little paint thereon can result in poor coverage and, because only a small portion of the brush contains paint, can make the application very time consuming. This leads some users to transfer paint out of the can entirely so that they can have more control over the manner in which they pick up paint with the painting tool.

While paint trays allow a user a greater degree of control in coating a brush with paint, when paint is first poured into the paint tray, this first step of transferring the paint from the can into the tray can result in drips and mess. Additionally, the plate of the tray may also be insufficient to remove excess paint from the tool being used. For example, most paint drays are designed for use with a paint roller and not a paint brush. When a brush is used and dipped directly into the well of the paint tray and then run along the plate to remove excess paint, the textured surface of the paint tray plate may be insufficient to remove enough of the excess paint from the brush. Using a brush with too much paint on it can result in too thick a coat of paint being applied to the surface, resulting in paint drips and a poor finished result. Moreover, when the project is completed, a quantity of paint often remains in the well of the paint tray. This paint must either be discarded, which is wasteful, or poured back into the paint can, which can be messy.

The disclosed devices and assemblies may advantageously reduce the likelihood of paint messes resulting from painting surfaces with a paint tool. For example, the disclosed devices and assemblies may facilitate painting directly from a quantity of paint in a paint can, thus eliminating the possibility of mess from transferring paint to a paint tray, while simultaneously eliminating excess paint build up on the paint can rim. The disclosed devices and assemblies may also eliminate paint waste and prevent brush bristles from contaminating the quantity of paint in the can. The disclosed devices may also be disposable or include disposable components, reducing the cleanup associated with painting.

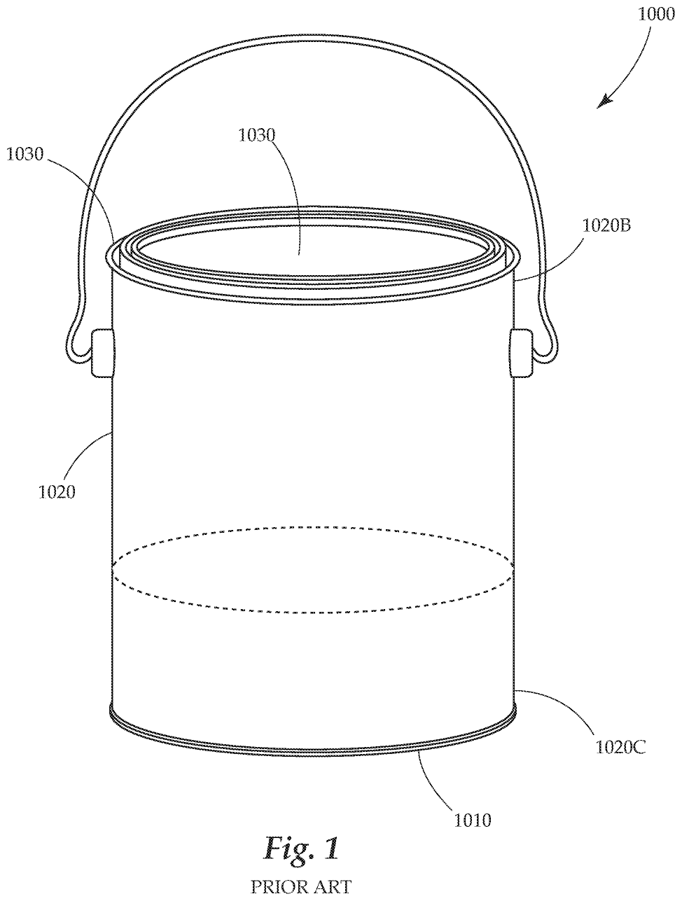

Paint is available for purchase in various quantities but is most often sold in various sized cans having common features. A traditional paint can 1000 containing paint 5 is shown in FIG. 1. Paint can 1000 has bottom 1010 and at least one side wall 1020 extending from bottom 1010. Most often and as shown in FIG. 1, base 1010 is circular and a single side wall 1020 extends from base 1010. Side wall 1020 has a bottom end 1020C that extends from base 1010 and a top end 1020B that terminates in rim 1030. Base 1010 and side wall 1020 form volume 1040. Paint 5 occupies a portion of volume 1040.

Paint cans 1000 come in a variety of sizes depending on the quantity of paint stored therein. For example, paint is sold in cans 1000 having various volumes 1040, including but not limited to pints, quarts, and gallons. Pint-sized paint cans have a bottom 1010, and therefore opening at rim 1030, having an approximate diameter of 3.25 inches and an approximate height of side wall 1020 of 4 inches. Quart-sized paint cans have a bottom 1010, and therefore opening at rim 1030, having an approximate diameter of 4.25 inches and an approximate height of side wall 1020 of 4.875 inches. Gallon-sized paint cans have a bottom 1010, and therefore opening at rim 1030, having an approximate diameter of 6.5 inches and an approximate height of side wall 1020 of 7.5 inches. The devices disclosed herein may be sized for use in any size can.

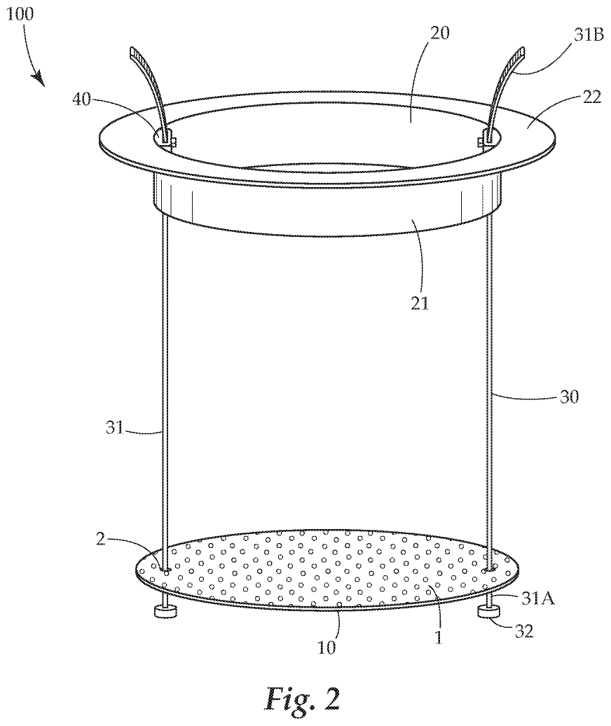

FIG. 2 shows an embodiment of a device 100 in accordance with the present disclosure. Device 100 has tray 10 and support top 20. Support top 20 includes support ring 21 and support flange 22. Tray 10 is suspended a distance from support top 20 by suspension system 30. Suspension system 30 has suspenders 31 having bottom end 31A and top end 31B. Suspenders 31 are secured to support top 20 at rachet boxes 40. Although two suspenders 31 are shown in FIG. 2, any number of suspenders may be used. The appropriate number of suspenders for a given can and paint will be readily ascertained by those skilled in the art. Ratchet boxes 40 are positioned on support top 20 and can be included within the body of support ring 21 or be affixed to the inner wall of support ring 21 such that they face inward towards the interior of paint can 1000. This ensures that support ring 21 can be inserted into paint can 1000 without being obstructed by ratchet boxes 40. Top end 31B of suspender 31 passes through rachet box 40 and bottom end 31B of suspender 30 passes through tray 10 at suspension holes 2 and terminate in stoppers 32. Tray 10 rests on stoppers 32. Tray 10 includes holes 1.

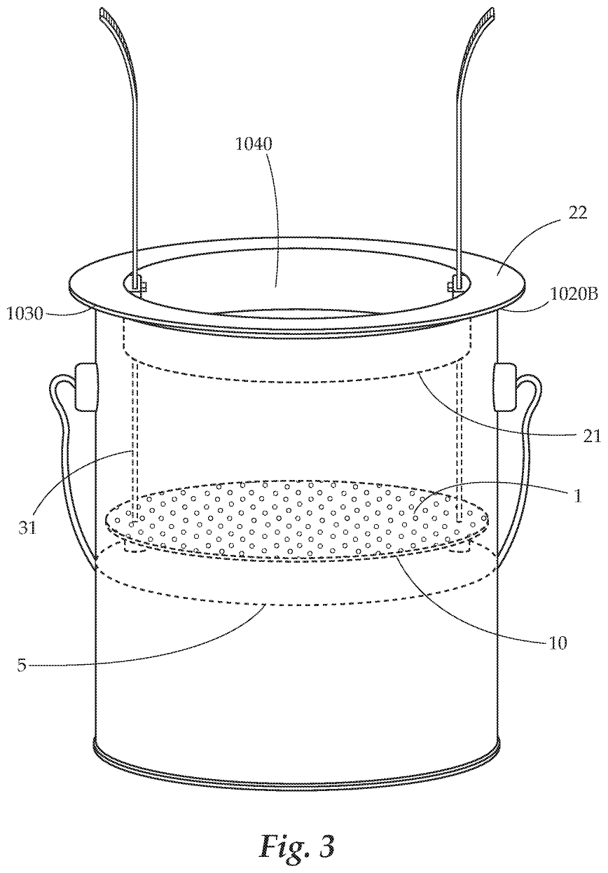

FIG. 3 shows an assembly of device 100 and paint can 1000 in accordance with aspects and embodiments of the present disclosure. Device 100 is inserted into paint can 1000 at top side wall 1020B such that support ring 21 is received in a portion of volume 1040 and support flange 22 rests on top of rim 1030. Tray 10 extends from support top 20 into volume 1040 by support system 30.

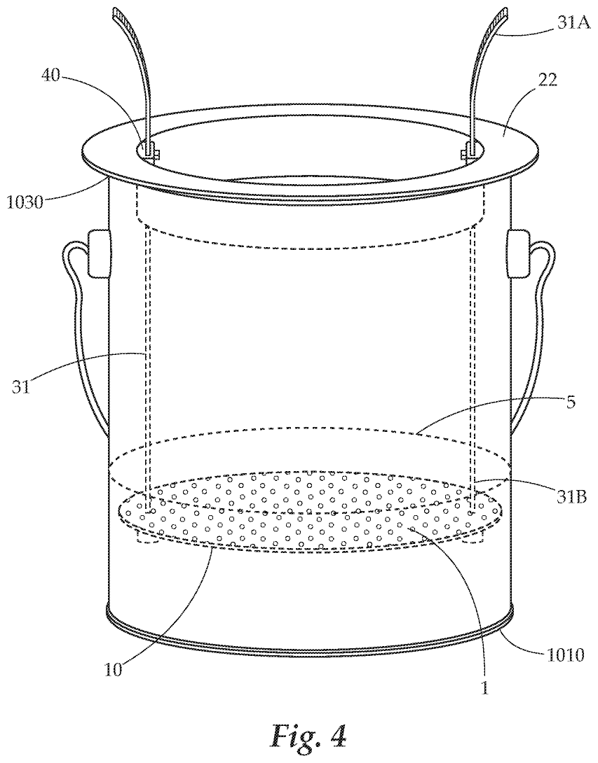

Turning now to FIG. 4, device 100 in paint can 1000 can be adjusted such that tray 10 submerges into quantity of paint 5. Support flange 22 keeps device 100 securely fixed on rime 1030 and the length of suspender 31 between ratchet box 40 and tray 10 is increased by exerted downward force on tray 10 such that tray 10 is pushed towards bottom 1010 of can 1000. As tray 10 is submerged into paint 5, paint 5 passes through holes 1 in tray 10, creating a thin layer of paint on tray 10. A brush or other painting tool may then be dipped into can 1000 to retrieve the thin layer of paint on top of tray 10. The thin layer that collects on tray 10 ensures that an adequate amount of paint is available to the brush while simultaneously ensuring that the brush does not take up an excess amount of paint.

As paint is used and the volume of paint in can 1000 decreases, tray 10 can be further extended towards bottom 1010 of can 1000 into paint 5. Referring to FIGS. 3-5, tray 10 the depth of tray 10, that is, how far into paint 5 tray 10 is submerged, is controlled by the length of suspenders 31 between ratchet box 40 and tray 10/end 31A of suspenders 31. Suspenders 31 have teeth 33 that allow suspenders 31 to pass through ratchet box 40 towards bottom 1010 of can 1000. Tray 10 can thus be moved incrementally downward into paint 5 by passing one or more teeth 33 through ratchet box 40. Ratchet box 40 is configured to allow excess length of suspender 31 at end 31B to be fed through ratchet box 40 to move tray 10 towards can bottom 1010. Ratchet box 40 is further configured to engage with teeth 33 to prevent tray 10 from moving upward and towards can rim 1030. Thus, when tray 10 is moved from a first, upper, position to a second, lower position, i.e., to a position closer to can bottom 1010, tray 10 locks into its new position in a manner that prevents tray 10 from returning to its first, upper, position, operating in the same manner as, for example, a traditional ratchet hand tool.

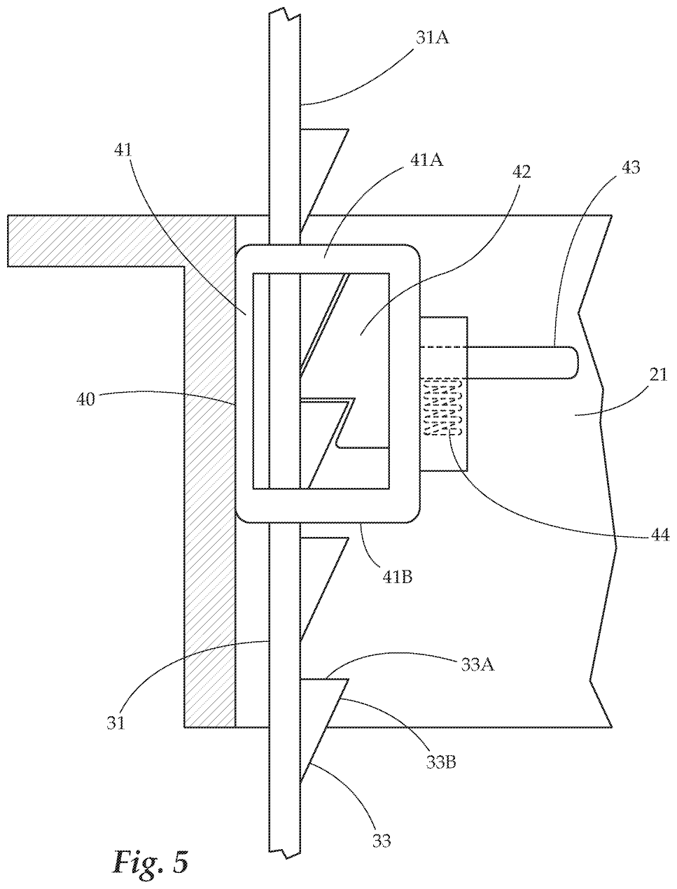

Turning to FIG. 5, ratchet box 40 has ratchet housing 41 and tang 42 in ratchet housing 41. Tang 42 has a shape that mates with teeth 33 of suspender 31. Tang 42 is urged towards teeth 33 of suspender 31 by spring 44 and lever 43. Suspender 31 passes through ratchet housing 41 into rachet housing 41 at the top of housing 41A and passes out of the ratchet housing 41 at bottom of housing 41B. Teeth 33 on suspender 31 are uniform but asymmetrical. In the embodiment shown in FIG. 5, each tooth 33 has first edge 33A that is flat, i.e., is perpendicular to the length of suspender 31. Side 33B of tooth 33 is at a substantial acute angle to the length of suspender 31. Tang 41 has a corresponding shape to teeth 33 that mates with teeth 33 and thereby holding tray 10 a fixed distance from support ring 21. When spring 44 is disengaged, tang 42 mates with a tooth 33 and allows side 33B of the tooth to pass downward, i.e., from a position closer to top of housing 41A to a position closer to bottom of housing 41A but does not allow side 33A of tooth 33 to pass from a lower position to an upper position. This allows tray 10 to be incrementally moved closer towards bottom 1010 of can 1000 as the volume of paint 5 decreases.

Although excess suspender length 31 is shown in FIGS. 2-4 as freely extending from ratchet box 40, in some embodiments excess suspender length may be contained within ratchet box 40. Suspenders 31 may be made of any suitable material, including but not limited to plastic and metal. The materials used for suspenders 31, and for all other parts of the devices disclosed herein, may be selected based on a number of factors, including if the device is intended for single or multiple uses, cost, and type of paint being used.

When a project is completed, tang 42 can be released from teeth 33 of suspender 31 by exerting force on tab 43. Tab 43 engages spring 44 and causes tang 42 to rotate about the axis of spring 44, thereby disengaging it from teeth 33. This allows suspender 31 to be passed from bottom of housing 41B through top of housing 41A, thereby decreasing the distance between support ring 21 and tray 10. This feature allows device 100 to be readjusted and reused. The distance between tray 10 and support ring 21 can be shortened to allow device 100 to be used in a new or fuller can of paint.

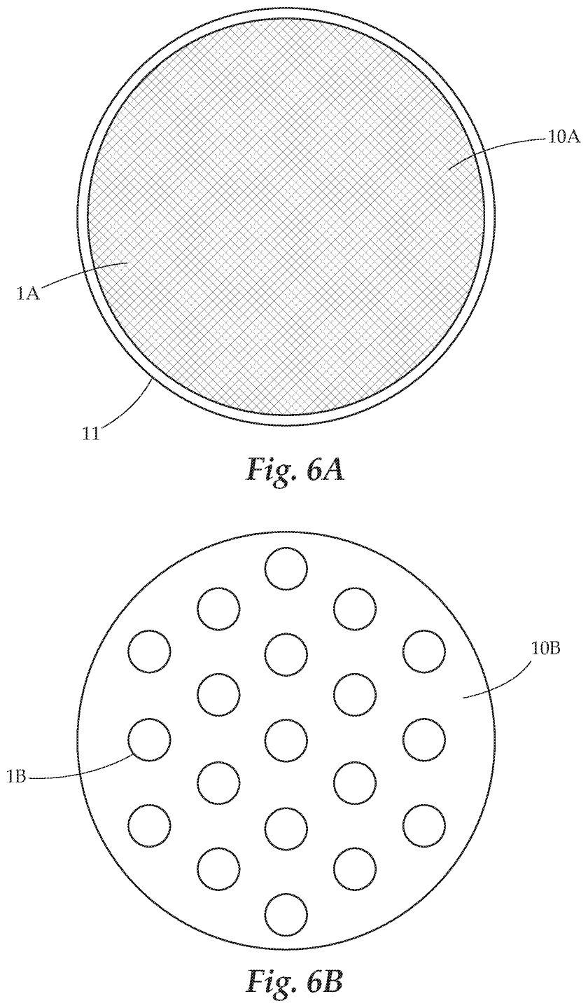

As shown in FIG. 6, tray 10 may have very fine through holes or larger through holes. As shown in FIG. 6A, through holes 1A of tray 10A may be very small and tray 10A may be mesh-like. Alternatively and as shown in FIG. 6B, tray 10 may have much larger through holes. Tray 10B has substantially larger through holes 1B. Various trays 10 having different size holes may be used in device 100. The size of holes 1 on tray 10 may be selected based on the type of paint being used, user preference, and other factors known in the art. Tray 10 may be made of any suitable material, including but not limited to wood, rubber, plastic, and metal, and more preferably, plastic or metal. In some embodiments, the manufacturing process of machining the through holes 1 into tray 10 may cause the circumference of the through holes on one side of tray 10 to be raised. This may advantageously provide a textured surface that assists a user in removing excess paint from a paint tool. Tray 10 additionally includes suspension holes for receiving suspenders 31 not shown in FIG. 6.

Tray 10 may also include gasket 11. Gasket 11 may fit around the circumference of tray 10 and abut side wall 1020 of paint can 1000. Gasket 11 may be made of any suitable material, preferably rubber, and further aid in holding tray 10 in place when it is intended to remain at a given height. Gasket 11 may also create a seal between the circumference of tray 10 and side wall 1020 such that if can 1000 containing paint 5 is inadvertently knocked over, paint 5 remains substantially contained, and passes only through the through holes 1 in tray 10. Gasket 11 may be removable from tray 10 to facilitate cleaning of tray 10 and gasket 11 after use or for re-use of gasket 11 in device 100 with a replacement tray.

In some embodiments, stoppers 32 on end 31A of suspenders 31 may be removable, thereby allowing different trays 10 having differently sized through holes 1 in a single device. Stoppers 32 may be removed from suspenders 31 to remove a first tray having through holes of a first size from the device. A second tray having through holes of a second size can be then be received by device 100 via suspension holes 2 and stoppers 32 can be reconnected to suspenders 31 to securely retain the tray. Alternatively, trays 10 may be replaced after use. Trays 10 may be intended for single use and may, for example, be disposable. After device 100 is used, tray 10 may be discarded, avoiding the need to have to clean the tray. A new, clean, replacement tray 10 may then be thread onto suspenders 31 for future use.

Device 100 may include additional features. For example, support top 20 may include a lip (not shown) for further wiping excess paint off a paint tool. A lip included in or on support 20 may advantageously face inward and thus any drips of paint that result from wiping excess paint off a paint tool simply fall back into the can. Additionally, because a support lip is on the support, it does not cause paint to accumulate in the can's rim and therefore allows for wiping without interfering with later sealing paint can 1000. A lip including with device 100 may snap-fit onto support top 20 and may be removable for cleaning.

Device 100 may be marketed and sold as a single or multiple use device. Device 100 may be marketed and sold with a single tray 10 as a stand-alone item or device 100 may be sold as a kit. A kit including device 100 may include any combination of a plurality of trays 10, gasket 11, and lip that connects to support top 20 for wiping off excess paint. The kit may further include extra stoppers 32 and/or additional tools to facilitate painting, including for example, paint stirrers, a paint brush, a drop cloth, and/or painter's tape. Kits including device 100 may include different combinations of trays and/or different combinations of supplemental tools for different projects. For example, a device 100 may be sold in a kit to aid in painting of trim, and the trays may be selected for the specific type of paint used for painting trim, and the kit may further include a specific brush for trim painting and painter's tape to tape off the areas around the trim. Moreover, more than one device 100 may be sold in a single kit, with a first device 100 being sized for a first sized paint can 1000 and a second device 100 being sized for a second sized can.

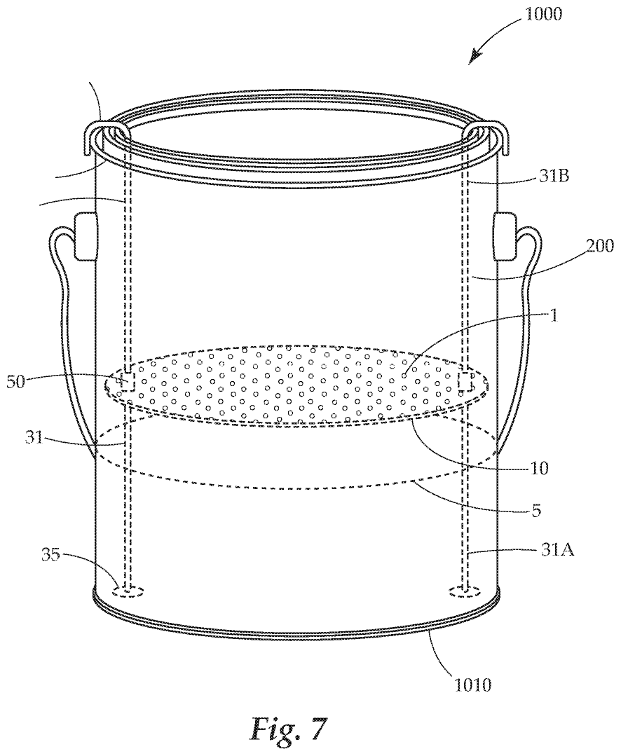

FIG. 7 shows an embodiment of a device 200 in accordance with the present disclosure. Device 200 has tray 10 having through holes 1 and suspenders 31. Suspenders 31 have a first end 31A and a second end 31B. End 31A terminates in feet 35 and end 31B terminates in hooks 34. Suspenders 31 have a length approximately equal to the height of paint can 1000 such that when hooks 34 are hooked onto rim 1030 of paint can 1000, feet 35 rest close to or on bottom 1010 of can 1000. Feet 35 may be weighted or provide weight to suspenders 31 to keep suspenders 31 substantially vertical when submerged in paint 5. Suspenders 31 pass through tray 10 at ratchet boxes 50. Although two suspenders 31 and two ratchet boxes 50 are shown in FIG. 2, i.e., device 200 has two suspender-ratchet box systems, any number of suspender-ratchet box systems may be used. The appropriate number of suspender-ratchet box systems for a given can and paint will be readily ascertained by those skilled in the art.

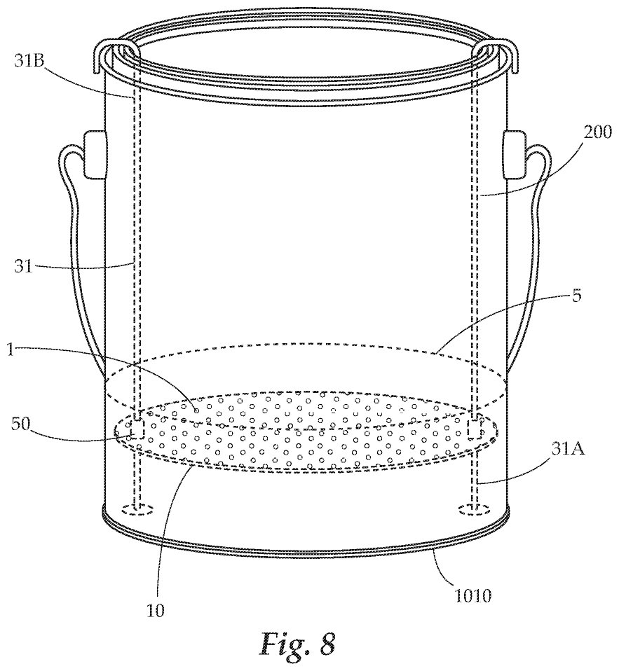

Turning also to FIG. 8, tray 10 may be pushed downward, i.e., towards bottom 1010 along suspenders 31. Suspenders 31 have the same teeth (not shown) as in device 100 and ratchet box 50 within tray 10 operates in the same manner as ratchet box 40. Ratchet box 50 may or may not have a mechanism that releases the internal tang from the suspender teeth. For example, device 200 may be designed to be a single use device, such that when tray 10 reaches end 31A of suspenders 31, the device is no longer usable. Alternatively, if device 200 has a mechanism from disengaging the tang in ratchet box 50, tray 10 can be readjusted for further use. Device 200 may also be sold in kits having various additional items.

Although certain representative embodiments and advantages have been described in detail, it will be apparent to those skilled in the art that various modifications and variations can be made in the present disclosure without departing from the scope or spirit of the disclosure. Other embodiments of the disclosure will be apparent to those skilled in the art from consideration of the specification and practice of the devices, assemblies, and methods disclosed herein. It is intended that the specification and examples be considered as exemplary only.

What is claimed is:

1. A paint device comprising:
a support system;
at least one suspender having a first end and a second end and extending from the support system;
a paint tray positioned at the second end of the at least one suspender; and
a stopper connected to the second end of the at least one suspender.

2. The paint device of claim 1, wherein the paint tray comprises a plurality of through holes.

3. The device of claim 2, wherein the support system comprises a support ring having a top end and a bottom end and a support flange extending radially from the top end of the support ring.

4. The device of claim 3, wherein the support ring further comprises at least one ratchet box having a top end and a bottom end that receives the at least one suspender.

5. The device of claim 4, wherein the device comprises a plurality of suspenders and ratchet boxes, with each ratchet box having a corresponding suspender.

6. The device of claim 5, wherein each ratchet box comprises a top end and a bottom end and the first end of the corresponding suspender extends from the top end and the second end of the corresponding suspender extends from the bottom end.

7. The device of claim 6, wherein each suspender comprises a plurality of teeth.

8. The device of claim 7, wherein each ratchet box comprises a tang configured to mate with the plurality of teeth.

9. The device of claim 8, wherein the tang allows the suspender to pass through the ratchet box in a direction from the top of the ratchet box to the bottom of the ratchet box but the tang does not allow the suspender to pass through the ratchet box in a direction from the bottom of the ratchet box to the top of the ratchet box.

10. The device of claim 9, wherein the distance between the paint tray and the support system is increasable by passing the corresponding suspender through the ratchet box in a direction from the top of the ratchet box to the bottom of the ratchet box.

11. The device of claim 10, wherein the distance is increasable in increments corresponding to the size of the teeth on the suspenders.

12. The device of claim 11, wherein the tang is releasable.

13. The device of claim 12, wherein when the tang is released, the suspender can pass through the ratchet box in the direction from the bottom of the ratchet box to the top of the ratchet box.

14. The device of claim 13, wherein the paint tray further comprises a gasket surrounding a perimeter of the paint tray.

15. The device of claim 14, wherein the support system further comprises a lip.

16. The device of claim 15, wherein the device is sized to be inserted into a paint can containing a quantity of paint, and wherein the support flange rests on a top rim of the can of paint, and the distance between the support system and the paint tray is adjusted to submerge the paint tray in the quantity of paint.

17. A paint device comprising:
a plurality of suspenders having teeth, each suspender having a first end and a second end, and each first end having a hook and each second end having a foot;
a paint tray comprising through holes positioned between the plurality of hooks and plurality of feet; and
wherein the paint tray includes plurality of ratchet boxes that receive the plurality of suspenders, with each ratchet box having a corresponding suspender.

18. The device of claim 17, wherein each ratchet box comprises a tang configured to mate with the teeth and the tang allows the paint tray to move on the suspenders in a direction from the first end of the suspenders towards the second end of the suspenders but the tang does not allow the paint try to move on the suspenders in a direction from the second end of the suspenders towards the first end of the suspenders.

19. The device of claim 18, wherein the distance between the paint tray and hooks is increasable by moving the paint tray down the suspenders in a direction from the first end of the suspenders towards the second end of the suspenders.

20. The device of claim 19, wherein the device is sized to be inserted into a paint can containing a quantity of paint, and wherein the hooks hook onto a top rim of the can of paint, and the distance between the hooks and the paint tray is adjusted to submerge the paint tray in the quantity of paint.
